(19) United States
(12) Patent Application Publication
(10) Pub. No.: US 2003/0065751 A1
(43) Pub. Date: Apr. 3, 2003

(54) Method for interrogating and proliferating a rack name in a rack of servers

(76) Inventors: Jeffrey S. Autor, Houston, TX (US); Andrew C. Cartes, Cypress, TX (US); Kevin M. Jones, Tomball, TX (US); Michael C. Sanders, Spring, TX (US)

Correspondence Address: CONLEY ROSE, P.C., P. O. BOX 3267, HOUSTON, TX, 77253-3267, US

(21) Appl. No.: 09/965,893

(22) Filed: Sep. 28, 2001

(51) Int. Cl. G06F 15/177

(52) U.S. Cl. 709/220; 709/223

(57) ABSTRACT

A method for propagating a rack name within a computer server rack. The rack comprises a plurality of server and/or power supply chassis, each with its own chassis controller. The name of the rack is stored in memory in each chassis controller. Rack names are propagated by requesting a rack name or receiving a command to set the rack name at each controller. The rack name is assigned to the rack via manual input through an external port in any of the servers. If a controller receives a rack name from this external port, this rack name is used. If the name comes from another controller and there is no existing name, the new name is accepted. If the new name differs from an existing rack name, the controller issues a naming conflict message and raises a conflict flag.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

1. Field of the Invention

The present invention generally relates to computer server rack naming. More specifically, the invention relates to a method of interrogating and propagating a server rack name among components within a rack.

2. Background of the Invention

In medium and large scale network and web server applications, computer hardware, especially interconnected server racks, contain numerous systems that can fill entire rooms. Datacenters such as these need a way to identify server and hardware locations so that system administrators may quickly and accurately locate problematic hardware. If a server goes down or otherwise needs attention, a system administrator may remotely query the server for its location thereby allowing that administrator to find the server. In essence, rack names create a library system for locating hardware. Part of this task is accomplished by assigning a logical name to individual racks. Whether by purpose, owner, function, or location, rack names are ordinarily assigned and updated manually. Hence, it is not uncommon for rack names to be maintained using crude, unsophisticated methods. For instance, rack names may be assigned using adhesive labels and the names of components within these racks may be stored in a stand-alone database, such as a spreadsheet. The manual nature of conventional rack naming methods makes these methods error-prone.

More sophisticated systems allow network administrators to manually enter rack names into individual servers to store rack names locally. In this configuration, an administrator may remotely access the server to determine the rack in which a server is located. However, a problem arises when a server is relocated to a different rack. Since the rack name is stored with the server, administrators must remember to change the rack name every time a server is relocated. If this information is not updated, the location of the server will be incorrect. This situation may lead to extended server downtime while an administrator attempts to locate a server for reboot or repair procedures.

In those systems that do store rack information on individual servers, it may be possible to share this rack name with other servers in the same rack. This may alleviate the need to manually enter rack names into every server in the same rack. However, this sort of information sharing is only feasible if the servers can communicate with one another. It is often desirable, and in some cases necessary, to have servers in the same rack running different operating systems. For example, servers within the same rack may be simultaneously running Windows, Linux, and UNIX operating systems for entirely different purposes. Communicating information such as a rack name between disparate operating systems may be done, but it is not a trivial task. Encoders and decoders are needed to translate OS-dependent rack information to a common format that is understandable by all systems. Given the simple nature of the information that needs to be shared, one may argue that the cost of implementing such designs outweighs the benefit received from rack name sharing.

In systems that do share rack names among servers within the same rack, security is another problem that arises. In many applications, including web servers, it is possible for multiple clients to share rack space. For example, a single rack may have front-end web servers for company X sharing space with equivalent servers for company Y. While it is desirable to share innocuous information such as rack or chassis locations between these servers, it is always risky to open an information sharing gateway between servers belonging to different organizations.

Another prior art solution involves assigning the rack name to a dedicated management controller that stores pertinent rack name and server information in a single location. This controller may be embodied as a designated server within the rack or may alternatively be implemented as a stand alone device. In either case, the management controller communicates the rack name information to all devices in the rack as needed. The problem with this solution is that the rack name information is stored in a single location and rack functionality may be prone to failure if the management controller fails or is replaced.

It would be desirable, therefore, to create an improved method of safely interrogating and proliferating a rack name among servers in a rack. The improved rack naming scheme would preferably be automated and allow a rack name to propagate through the components within a rack when a rack name is assigned. In addition, the improved method would advantageously allow administrators to replace servers within a rack without requiring a rack name reassignment because new equipment added to a configured rack automatically receives the rack name from the existing peer equipment. Furthermore, the improved rack naming method would preferably provide some form of naming redundancy and peer communication to eliminate dependence on a single source point for the rack name.

### BRIEF SUMMARY OF THE INVENTION

The problems noted above are solved in large part by a computer server rack, which preferably includes a plurality of modular server chassis and at least one modular power supply chassis. The server chassis are configured to hold a plurality of computer servers and the power supply chassis is configured to hold a plurality of power supplies. Each chassis further includes a chassis controller comprising a processor, a flash memory, and a system memory. Each controller also includes an internal bus port through which the controller may communicate with other controllers and a device bus port through which the controller may communicate with other devices in the same chassis. The name of the rack is preferably stored in flash memory.

The server rack also includes an internal communications bus coupling each of the chassis controllers. Preferably, the chassis controllers transmit and receive the server rack name on this internal communications bus. The servers in the rack preferably include an external port. The rack name is assigned to the rack via manual input through this external port. Each chassis controller further comprises a conflict flag, preferably embodied as a bit field in memory, such that if a controller receives a rack name from the internal communications bus that differs from the rack name stored in flash memory, the controller issues a naming conflict message and changes the position of the conflict flag. The naming conflict message may be a warning to a server administrator. By default, if the controller receives a rack name from the device bus by way of an external port, the new name is written to flash memory. Similarly, if a controller receives a conflict message from the internal bus, the existing name in flash memory is invalidated.

The rack name can be propagated within the rack by one of two methods. First, a controller may request a rack name from another controller. Second, a controller may receive a command from another location to set a new rack name. In the latter method, the controller determines if the rack name was received from a transmitting chassis controller along the internal bus or from an external port. If the rack name was received from an external port, the controller sets the rack name within the chassis controller. If the rack name is received from the internal bus, the controller determines whether the transmitting controller is authorized to issue the request to the receiving chassis controller. If, on the one hand, the transmitting chassis controller is authorized to issue the request, the rack name is set within the receiving chassis controller and the new rack name is forwarded along the internal bus. If, on the other hand, the transmitting chassis controller is not authorized to issue the request, the receiving controller issues a security alert.

In the former method, a controller issues a request for a rack name to a second chassis controller. In general, the requesting controller receives some response from the second chassis controller. The requesting controller first determines whether it has an existing rack name and if no existing rack name exists and the response includes a new rack name, the new rack name is set within the requesting controller. If there is an existing rack name and it matches the rack name received from the second chassis controller, the rack name is kept without change.

If, however, an existing rack name does not match the rack name received from the second chassis controller, a name conflict flag is raised and the naming conflict is reported to a system administrator. Similarly, if the requesting controller has an existing rack name and if the response from the second chassis controller does not include a rack name nor a naming conflict flag, the requesting controller propagates the internal rack name to other chassis controllers. Lastly, if the response from the second chassis controller includes a naming conflict flag, the requesting controller raises a naming conflict flag. In either method, after raising a conflict flag, the local copy of the rack name is invalidated. After setting a new rack name, a controller always clears any naming conflict flags.

### BRIEF DESCRIPTION OF THE DRAWINGS

For a detailed description of the preferred embodiments of the invention, reference will now be made to the accompanying drawings in which:

FIG. 1 shows a pictorial representation of three computer server racks in accordance with the preferred embodiment;

FIG. 2A shows a schematic representation of the preferred interconnection between various components within a single rack in which the preferred embodiment is incorporated;

FIG. 2B shows a schematic representation of an alternative interconnection between various components within a single rack in which the preferred embodiment is incorporated;

FIG. 3 shows a flow chart describing the preferred rack name interrogation process; and

FIG. 4 shows a flow chart describing the preferred rack name proliferation process.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

Although the term “rack” is used herein in the context of an EIA standard 19″ mounting rack to which server or power supply chassis and standard laboratory equipment are mounted, the term is intended to more broadly refer to any structure to which electronic components are mounted and which is given a name. In the description that follows, a “chassis” is a modular component in which servers and power supplies are installed. In general, a number of chassis may be installed in the same rack.

### DETAILED DESCRIPTION OF THE PREFERRED EMBODIMENTS

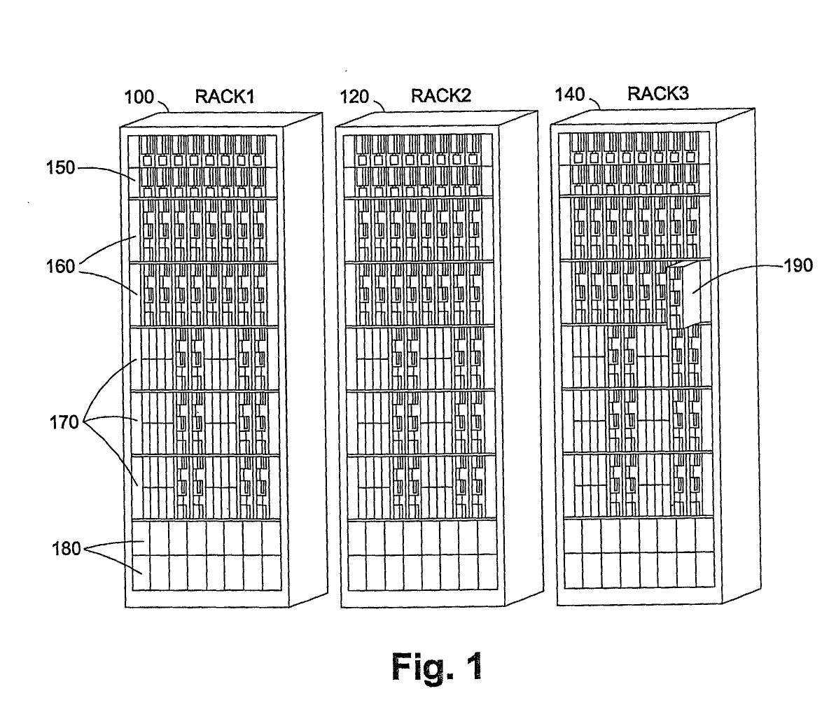

Referring now to FIG. 1, rack systems 100, 120, 140 represent server racks in accordance with the preferred embodiment and comprise various chassis, server, and power supply components as depicted. The racks 100, 120, 140 also preferably have a name associated with the rack that is used to identify the location of the various components. In FIG. 1, these racks are designated Rack1, Rack2, and Rack3. For illustrative purposes, each rack is fitted with identical hardware comprising: front end servers 150, application servers 160, back-end servers 170 and power supplies 180. Power supplies 180 are preferably redundant supplies that provide power to servers 150, 160, 170. The racks 100, 120, 140 may also be fitted with other hardware and in different configurations as will be recognized by those skilled in the art. For the purposes of this description of the preferred embodiment, however, it may be assumed that each rack includes the same hardware.

Each of the servers 150, 160, 170 are preferably encased in a modular, removable housing called a “blade” 190. These blades 190 are installed in any of a plurality of modular chassis subframes within racks 100, 120, 140. Though not necessarily discernable from FIG. 1, each rack is preferably comprised of six server chassis and 2 power chassis. Server blades 190 are designed to be fully interchangeable with one another. Thus, if a server goes down and needs to be replaced, the existing blade is simply swapped for a new blade. Front end servers 150 are preferably designed for less demanding tasks than the application servers 160 and back-end servers 170. For example, a front-end server 150 might be used for tasks such as an individual web servers or for dedicated applications such as firewalls or for DNS lookup. Application servers 160, on the other hand, may be used for more complex web and ASP (Application Service Provider) hosting or media streaming. Back-end servers 170 might be used as database servers or as gateways to a storage area network.

The blade form factor for front-end servers 150 may be smaller than for application 160 and back-end 170 servers. Similarly, application servers 160 are less powerful and can be made to occupy less space than back-end servers 170. However, in accordance with the preferred embodiment, each of these types of server blades may be installed in any location within the server rack 100, 120, 140. More specifically, the server chassis are preferably configured to accept any type of server 150, 160, 170. Naturally, the size of the various types of servers 150, 160, 170 will determine how many of each server will fit in a given chassis.

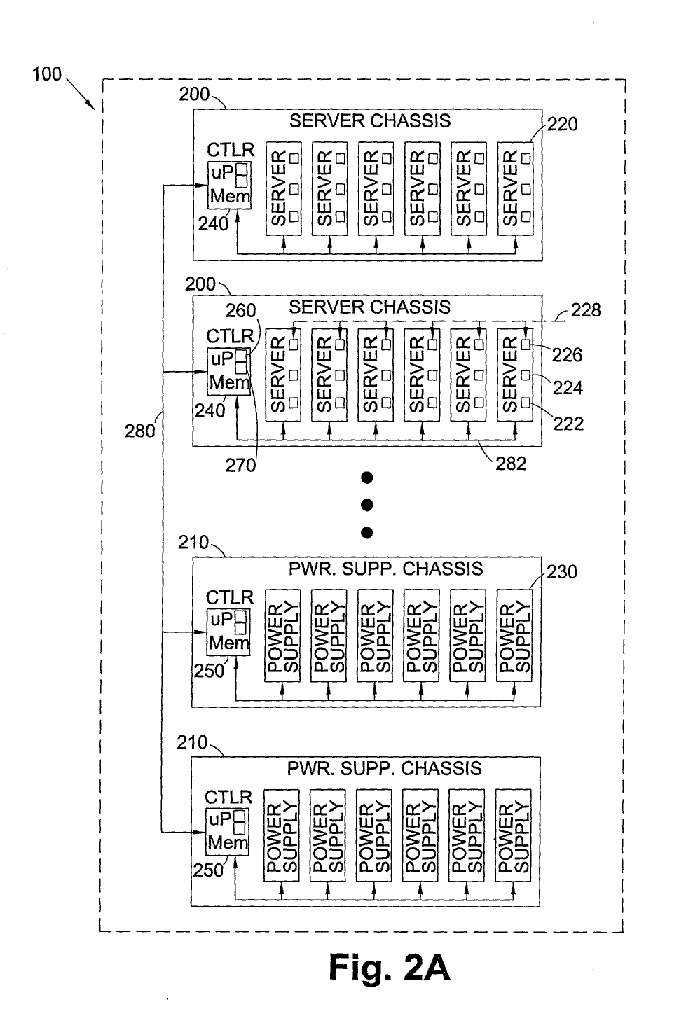

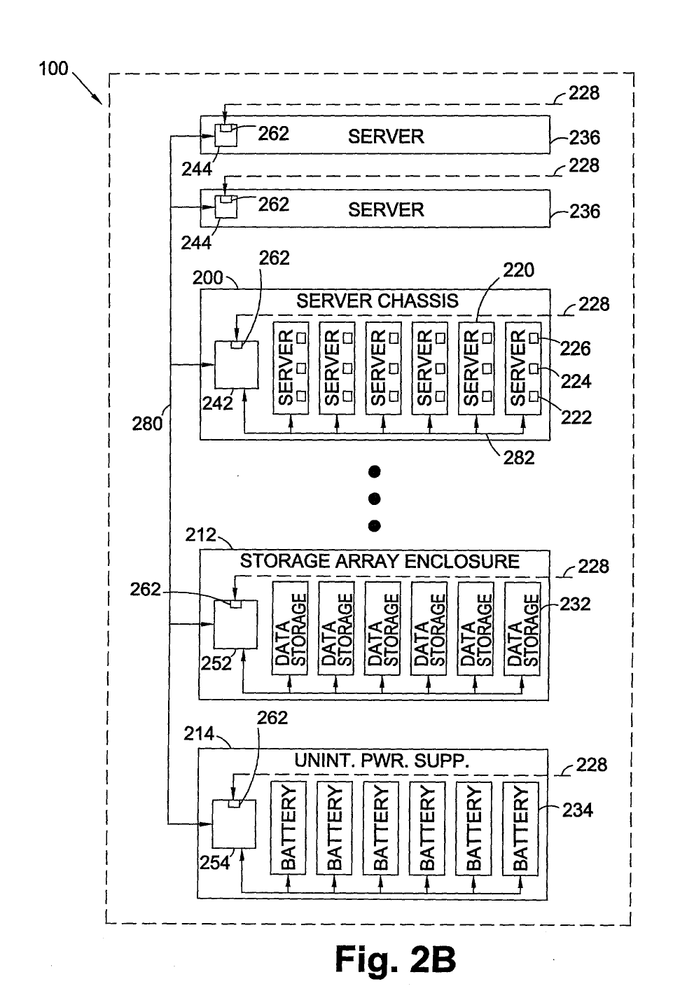

Referring now to FIG. 2A, a schematic representation of rack 100 is shown. Rack 100 is preferably comprised of multiple server chassis 200 and power supply chassis 210. As discussed above, each server chassis 200 can hold a plurality of servers 220. (Servers 220 are equivalent to servers 150, 160, 170 in FIG. 1.) In FIG. 2A, each server chassis 200 includes six servers 220, although in practice, this number will vary depending on the size of the servers. Similarly, power supply chassis 210 includes six power supplies 230, but this number may vary depending on the size of the power supplies and the overall power requirements for rack 100.

Servers 200 are computing devices comprising, at a minimum, a processor 222, a memory device 224, and a network device 226. Network device 226 provides various management facilities and includes an I/O processor that is used to provide intelligent control of the management architecture in the server 220. In addition, this network device 226 also preferably includes one or more “out-of-band” communication interfaces such as a network interface to device bus 282 and an external port 228. These interfaces permit communication with other servers and controller 240 and also enable remote monitoring, control, and detection of various system management events

In accordance with the preferred embodiment, each server chassis 200 includes a server controller 240 and each power supply chassis 210 includes a power controller 250. Controllers 240, 250 are preferably interconnected via an internal bus 280. Each controller 240, 250 is responsible for monitoring and aggregating information from the components within that chassis. This device information is gathered along device bus 282 and shared with other peer controllers 240, 250 in the rack over internal bus 280. The power controllers 250 are also configured to cooperate with one another to provide a constant view of power distribution and power requirements within the rack 100. Each controller 240, 250 includes a micro-processor 260 and a flash memory device 270, which is preferably used to store the rack name in accordance with the preferred embodiment. The controller devices 240, 250 may also include other components not specifically shown in FIG. 2A such as additional system memory for storing program instructions, voltage converters, and bus switches. The actual design of the controllers 240, 250 and the functions they perform may vary to the extent that they still execute the improved rack naming method disclosed herein.

The rack name is preferably stored in a predetermined location in flash memory 270 as a binary representation of an ASCII word or phrase. Logical names such as a customer name or arbitrary names such as the Kings of England are possible examples and are sufficient for this purpose. The storage of this type of information in memory is standard and is well known to those skilled in the art.

According to the preferred embodiment, servers 220 within rack 100 can receive rack name information from one of at least two different locations. The first location is from the server controller 240 located within the same chassis 200. This presumes that the rack is powered up and running and that the rack name has been fully propagated to each of the controller devices 240, 250. The method by which the controllers 240, 250 request and propagate the rack name is discussed in further detail below. During normal operations, server 220 simply requests the rack name from controller 240 where the name is retrieved from flash memory 270.

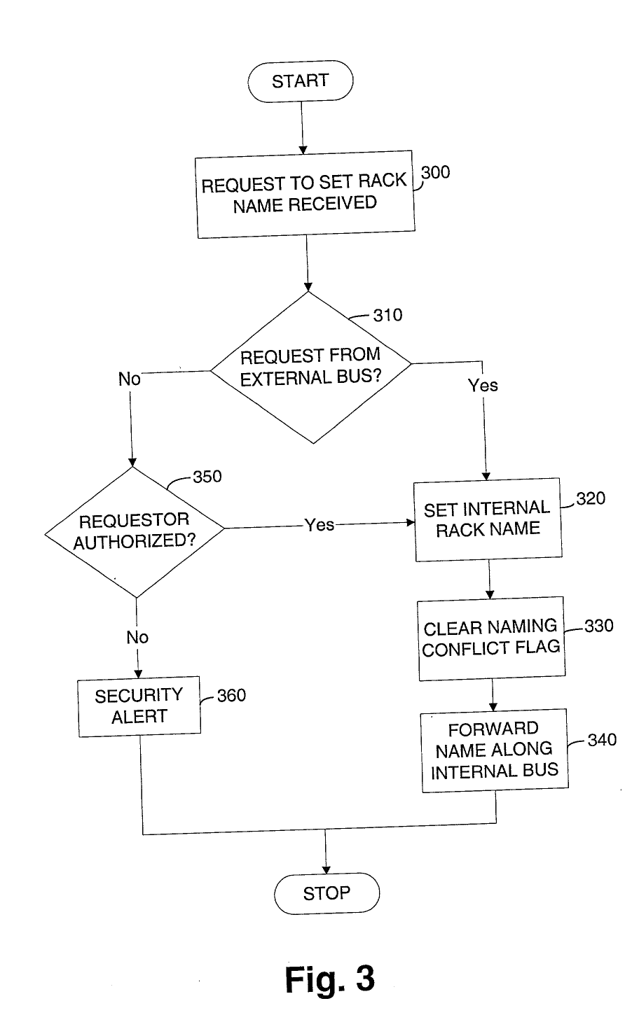

The second location from which a server 220 may obtain the rack name is via the external port 228 to network device 226. A server administrator may use this external port to enter a rack name whenever the rack is initially deployed or when there is a naming conflict reported by the system. The external interface 228 may include an RS-232 serial port, an RJ-45 network connection, or some other suitable access port. In any case, the administrator can access the network device of any server 220 in the rack to enter the rack name. It is also feasible, given the remote networking capability of server 220, for an administrator to remotely connect to a server and enter a rack name from a different location. However, for security reasons (and as discussed below), it is envisioned that priority be given to rack names received via external port 228. After receiving the new rack name from external port 228, a server 220 will propagate this name to its associated controller 240 in the form of a request from the server 220 to set the rack name. In general, controllers 240, 250 handle these requests according to the flow diagram shown in FIG. 3.

An important advantage of the preferred rack naming scheme is that it is not limited to racks incorporating only the preferred components shown in FIG. 2A. The peer rack naming scheme may be applied to any rack system in which peer devices or peer controllers can successfully share the rack name along internal bus 280. For example, the schematic diagram shown in FIG. 2B represents an alternative, more general embodiment of a rack implementing the preferred rack naming method.

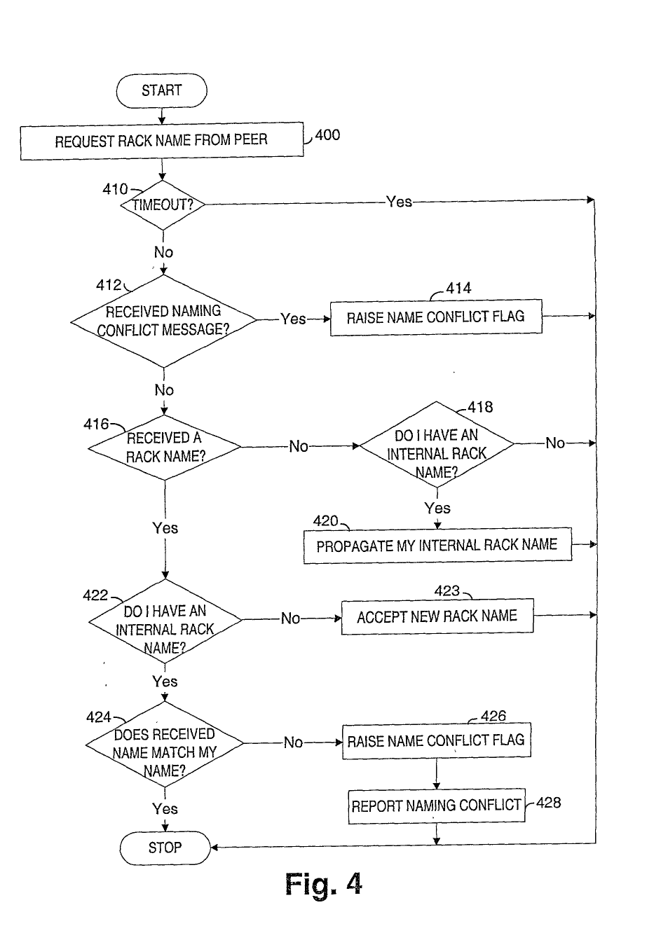

FIG. 2B shows a rack system comprising a number of devices including a server chassis 200 of the type shown in FIG. 2A. Also shown are a data storage array enclosure 212 comprising an array of data storage devices 232, an uninterruptible power supply (UPS) 214 comprising an array of backup batteries 234, and a pair of conventional rack mount servers 236. In accordance with the preferred peer rack naming method, each device in the rack preferably includes a controller capable of communicating along internal bus 280. The conventional rack mount servers 236 preferably include a system management controller 244 similar to network device 226 or some other controller capable of storing and executing the preferred rack naming algorithms described below and shown in FIGS. 3 and 4. Similarly, the storage array 212 and UPS 214 also preferably include peer controllers 252 and 254, respectively.

Each of the peer controllers may advantageously include a communications port 262 which may be accessed by a system administrator, preferably as an external port 228 through which the rack name may be manually assigned. Similarly, server chassis 200 may also have a modified controller 242 as shown in FIG. 2B. This alternative chassis controller 242 differs from controller 240 as shown in FIG. 2A in that it also includes a communications port 262 accessible by external port 228. Thus, alternative chassis controller 242 is capable of directly receiving a rack name from a system administrator who directly connects to port 262. This embodiment differs only in the sense that the rack name is assigned to the rack by manually entering the rack name through the controller 242 instead of through an individual server 220.

FIG. 3 shows the general decision path executed by controllers 240, 250 that receive a command to set the rack name 300. In accordance with step 310, the controller 240, 250 first determines whether this request has come from the external port 228 of a server 220, or via the internal bus 280. If the request has been entered externally by an administrator, the rack name is set 320 by writing the name to flash memory 270. Any naming conflicts that may have been previously detected by controller 240, 250 are cleared 330 and the new rack name is then forwarded 340 along internal bus 280.

In the event the new rack name is received via internal bus 280, the controller 240, 250 first determines whether the requesting device (presumably another controller 240, 250) is authorized to request the name change 350. Administrators may optionally set up security blocks between chassis 200, 210 to limit data transfers between controller devices 240, 250. This might be done in racks where wholly different systems, perhaps owned by different companies, are running on the same rack. Thus, by setting security authorizations, unwanted transfers of data may be kept in check. This security authorization information is preferably stored in each controller device 240, 250. If the device requesting a name change is not authorized to propagate this name information, the receiving device raises a security alert 360 and an administrator is notified. Otherwise, if the requesting device is authorized to propagate the name change, the receiving device accepts the new name and executes the remaining steps 320, 330, 340 as if the request were received from an external port 228.

Referring now to FIG. 4, a flow chart is shown describing the method by which a controller device 240, 250 requests a rack name. This process may be executed on power up, after a component change, or even periodically. In general, the process is repeated until every controller device 240, 250 in the rack has or accepts a common rack name or alternatively receives or reports a naming conflict. The process begins when a controller device 240, 250 requests a rack name from a peer device (240, 250) 400. If, after sending this request to a peer device, no response is detected, a timeout occurs 410 and the instant request stops. A lack of response may indicate that a chassis is disabled or not in use in this particular rack. The controller device 240, 250 may then request the rack name from a different peer. In general, each controller device 240, 250 is capable of requesting a rack name from every other peer, thereby permitting all live controllers to share the rack name with one another.

If, on the other hand, a connection is established between a requesting controller 240, 250 and a peer, one of several possible replies may be sent by the peer device in response to the rack name request. One option, as represented by step 412, is that a naming conflict may be received. Another reply is the rack name itself (represented by step 416), which must be checked against the current rack name, if any, to determine if a local naming conflict exists. A naming conflict message indicates that a controller device 240, 250 in the propagation chain has detected a naming conflict. Thus, since there is no name that can be reliably used for the rack, the controller devices are simply informed of the conflict, raise an internal conflict flag 414, and await a command to set the rack name, which is preferably propagated once an administrator resolves the name conflict. Once the internal conflict flag is raised, the rack name in flash memory is preferably invalidated or erased to prevent distribution of an invalid rack name.

Even if a connection handshake is established between peer controllers 240, 250, it is still possible that neither a naming conflict nor a rack name will arrive at the requesting controller. This may happen if the peer device has no rack name stored locally, as in when a rack is initially deployed. In this event, the requesting controller 240, 250 checks in step 418 to see if there is an internal name stored in flash memory 270. If there is no name stored locally, the request ends. The controller 240, 250 may alternatively request the rack name from a different peer, wait to ask the same peer again at a later time, or simply await receipt of a rack name from another peer. However, if after a rack name request is sent neither a naming conflict nor a rack name arrives, but an internal rack name does exist, the internal rack name is presumed to be valid and this name is propagated to the other controllers 240, 250 (step 420).

As mentioned above, if a rack name arrives in response to a rack name request, the new rack name is preferably checked against any existing names for a conflict. First, the requesting controller 240, 250 determines whether there is an internal rack name (step 422). If there is no internal rack name, the requesting controller 240, 250 accepts the new name 423 as valid and writes the name to flash memory 270. If there is an internal name, the requesting controller 240, 250 checks to see if the new name matches the internal name (step 424). If the names match, the existing name is retained. If, on the other hand, the names do not match, the controller 240, 250 sets or raises an internal conflict flag (step 426), which may consist of a bit field in a processor register, a binary value stored to memory, or some other suitable conflict notification method. In addition, because the requesting controller 240, 250 is the device that identified the naming conflict, this controller reports the naming conflict as appropriate 428. A system administrator is preferably notified of this conflict using conventional means, such as via email or pager alerts or possibly even by visual alerts using LEDs or any other desirable warning indication. Once alerted, an administrator will need to manually enter a new name to resolve the conflict and this new name is preferably propagated through the rack to all controller devices 240, 250 using the methods described herein.

The improved rack naming method described above provides a number of advantages over conventional schemes. First of all, since the rack names are not stored on individual servers, servers may be inserted and removed from a rack without creating any naming conflicts. Furthermore, the rack name may be propagated as servers or other peer devices are hot swapped in the rack, thereby eliminating any potential naming conflicts. Also, the rack names are stored using a scheme that is independent of any operating systems, which permits name sharing among all devices in the same rack. Lastly, the naming scheme is fully automatic, identifies conflicts, and includes security provisions for unwanted server access.

The above discussion is meant to be illustrative of the principles and various embodiments of the present invention. Numerous variations and modifications will become apparent to those skilled in the art once the above disclosure is fully appreciated. For example, whereas the naming scheme described herein has been geared towards a preferred implementation in server racks, the same methods may be used to name racks of laboratory equipment or test equipment. It is intended that the following claims be interpreted to embrace all such variations and modifications.

What is claimed is:

1. A computer server rack, comprising:
a plurality of modular server chassis configured to hold a plurality of computer servers, each chassis comprising a chassis controller having a processor and a memory, and
an internal communications bus coupling each of the chassis controllers;
wherein the chassis controllers transmit and receive a server rack name on the internal communications bus; and
wherein the name of the rack is stored in the memory in each chassis controller.

2. The server rack of claim 1 further comprising at least one modular power supply chassis configured to hold a plurality of power supplies and further comprising a chassis controller having a processor and a memory.

3. The server rack of claim 1 further comprising an external port in at least one of the computer servers;
wherein the rack name is assigned to the rack via manual input through the external port.

4. The server rack of claim 3 wherein each chassis controller further comprises a conflict flag;
wherein if a controller receives a rack name from the internal communications bus that differs from the rack name stored in memory, the controller issues a naming conflict message and changes the position of the conflict flag.

5. The server rack of claim 4 wherein the conflict flag is a bit field in the chassis controller.

6. The server rack of claim 4 wherein the naming conflict message is warning to a server administrator.

7. The server rack of claim 1 wherein;
the memory in which the rack name is stored is flash memory.

8. A chassis controller deployable in a server rack comprising:
a processor;
a system memory;
a flash memory;
an internal bus port through which the controller may communicate with other controllers;
a device bus port through which the controller may communicate with other devices in the same chassis;
wherein the name of the rack in which the chassis is disposed is stored in flash memory.

9. The chassis controller of claim 8 wherein:
if the controller receives a rack name from the device bus, the new name is written to flash memory.

10. The chassis controller of claim 9 wherein:
the controller receives a rack name from the internal bus, the new name is compared with the rack name in flash memory to check for name conflicts.

11. The chassis controller of claim 10 further comprising:
if the controller receives a conflict message from the internal bus, the existing name in flash memory is invalidated.

12. A method of propagating a rack name within a server rack, comprising:
receiving a request to set the rack name at one of a plurality of chassis controllers; and
determining if the rack name was received from a transmitting chassis controllers along an internal bus or from an external port;
wherein if the rack name was received from an external port, setting the rack name within the chassis controller.

13. The method of claim 12, wherein:
if the rack name is received from the internal bus, determining whether the transmitting chassis controller is authorized to issue the request to the receiving chassis controller; and
if the transmitting chassis controller is authorized to issue the request, setting the rack name within the receiving chassis controller

14. The method of claim 13, wherein:
if the transmitting chassis controller is not authorized to issue the request, issuing a security alert.

15. The method of claim 13, further comprising:
forwarding the new rack name along the internal bus to another of the plurality of chassis controllers.

16. The method of claim 13, further comprising:
clearing any naming conflict flags after setting the new rack name.

17. A method of propagating a rack name within a server rack, comprising:
issuing a request for a rack name from a first to a second of a plurality of chassis controllers; and
receiving a response from the second chassis controller at the first chassis controller; and
determining whether the first chassis controller has an existing rack name;
wherein if no existing rack name exists and the response includes a new rack name, setting the rack name within the first chassis controller.

18. The method of claim 17, wherein:
if an existing rack name matches the rack name received from the second chassis controller, keeping the rack name within the first chassis controller.

19. The method of claim 17, wherein:
if an existing rack name does not match the rack name received from the second chassis controller, raising a name conflict flag and reporting the naming conflict to a system administrator.

20. The method of claim 17, wherein:
if the first chassis controller has an existing rack name and if the response from the second chassis controller does not include a rack name nor a naming conflict flag, propagating the internal rack name to other chassis controllers.

21. The method of claim 17, wherein:
if the response from the second chassis controller includes a naming conflict flag, raising a naming conflict flag.

22. A method of propagating a rack name within an electronics rack, comprising:
receiving a request to set the rack name at one of a plurality of peer controllers; and
determining if the rack name was received from a transmitting peer controllers along an internal bus or from an external port;
wherein if the rack name was received from an external port, setting the rack name within the peer controller.

23. The method of claim 22, wherein:
if the rack name is received from the internal bus, determining whether the transmitting peer controller is authorized to issue the request to the receiving peer controller; and
if the transmitting peer controller is authorized to issue the request, setting the rack name within the receiving peer controller

24. The method of claim 23, wherein:
if the transmitting peer controller is not authorized to issue the request, issuing a security alert.

25. The method of claim 23, further comprising:
forwarding the new rack name along the internal bus to another of the plurality of peer controllers.

26. The method of claim 23, further comprising:
clearing any naming conflict flags after setting the new rack name.

27. A method of propagating a rack name within an electronics rack, comprising:
issuing a request for a rack name from a first to a second of a plurality of peer controllers; and
receiving a response from the second peer controller at the first peer controller; and
determining whether the first peer controller has an existing rack name;
wherein if no existing rack name exists and the response includes a new rack name, setting the rack name within the first peer controller.

28. The method of claim 27, wherein:
if an existing rack name matches the rack name received from the second peer controller, keeping the rack name within the first peer controller.

29. The method of claim 27, wherein:
if an existing rack name does not match the rack name received from the second peer controller, raising a name conflict flag and reporting the naming conflict to a system administrator.

30. The method of claim 27, wherein:
if the first peer controller has an existing rack name and if the response from the second peer controller does not include a rack name nor a naming conflict flag, propagating the internal rack name to other peer controllers.

31. The method of claim 27, wherein:
if the response from the second peer controller includes a naming conflict flag, raising a naming conflict flag.

32. An electronics rack, comprising:
a plurality of modular devices, each device including a peer controller comprising a processor and a memory; and
an internal communications bus coupling each of the peer controllers;
wherein the peer controllers transmit and receive a server rack name on the internal communications bus.

33. The electronics rack of claim 32 wherein:
the name of the rack is stored in the memory in each peer controller.

34. The electronics rack of claim 33 further comprising an external port in at least one of the peer controllers;
wherein the rack name is assigned to the rack via manual input through the external port.

35. The electronics rack of claim 34 wherein each peer controller further comprises a conflict flag;
wherein if a peer controller receives a rack name from the internal communications bus that differs from the rack name stored in local memory, the peer controller issues a naming conflict message and changes the position of the conflict flag.
